(19) United States
(12) Patent Application Publication
(10) Pub. No.: US 2006/0209458 A1
(43) Pub. Date: Sep. 21, 2006

(54) Soft magnetic film and thin film magnetic head

(75) Inventors: Junichi Kane, Kawasaki (JP); Yuji Uehara, Kawasaki (JP); Kenji Noma, Kawasaki (JP); Akifumi Chikazawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/158,257

(22) Filed: Jun. 21, 2005

(30) Foreign Application Priority Data
Mar. 16, 2005 (JP) 2005-75238

(51) Int. Cl. G11B 5/147

(52) U.S. Cl. 360/126

(57) ABSTRACT

The soft magnetic film has superior soft magnetic characteristics and is suitable for a thin film magnetic head. The soft magnetic film of the present invention comprises: a magnetic base layer including a ferromagnetic element; and a ferromagnetic layer being piled on the magnetic base layer. The soft magnetic film has uniaxial magnetic anisotropy. The magnetic base layer includes at least one element selected from Fe, Ni and Co as the ferromagnetic element.

### BACKGROUND OF THE INVENTION

The present invention relates to a soft magnetic film and a thin film magnetic head.

In a magnetic disk drive unit, a thin film magnetic head is used for writing data in and reproducing data from a recording medium. The thin film magnetic head has an upper magnetic pole and a lower magnetic pole, which are magnetic layers, and a gap layer, which is a nonmagnetic layer and provided between the magnetic poles. A magnetic field is generated between the upper and lower magnetic poles so as to write data in the medium.

The thin film magnetic head is capable of increasing saturation magnetic flux density of the magnetic poles so as to improve recording density. Thus, a magnetic film (soft magnetic film) having high saturation magnetic flux density and soft magnetic characteristics is required.

The applicant of the present invention invented a thin film magnetic head having a soft magnetic film (see Japanese Patent Gazette No. 2003-229310). The thin film magnetic head is shown in FIG. 11. A nonmagnetic layer 37 and a nonmagnetic base layer 38a are provided between ends of a lower magnetic pole 34 and an upper magnetic pole 35. The upper magnetic pole 35 is formed on a ferromagnetic layer 35a. A symbol 31 stands for a coil pattern. An MR element 41, which is a read-element, is provided between an upper shielding layer 43 and a lower shielding layer 44.

In the conventional thin film magnetic head shown in FIG. 11, the nonmagnetic base layer 38a, which is piled on the nonmagnetic layer 37, is nonmagnetized by, for example, adding Cr of 25 at % or more to an alloy of NiFe. A soft magnetic film, which is formed by forming the ferromagnetic layer 35a, e.g., FeCo layer, on the nonmagnetic base layer 38a, has superior soft magnetic characteristics, so it is a suitable for the thin film magnetic head.

However, the upper magnetic pole 35 is formed by forming a resist pattern on a surface of the ferromagnetic layer 35a and forming a magnetic film by plating. After forming the upper magnetic pole 35, the resist pattern is removed. Further, unwanted parts in the ferromagnetic layer 35a and a magnetic base layer 38 are removed by etching, but it is difficult to etch the nonmagnetic base layer 38a. If the ferromagnetic layer 35a is exposed, it is easily corroded.

Further, in the conventional thin film magnetic head, the nonmagnetic base layer 38a is formed under an insulating layer 39. Therefore, the insulating layer 39 is formed after forming the nonmagnetic base layer 38a, then the ferromagnetic layer 35a is formed. Namely, the nonmagnetic layer 38a and the ferromagnetic layer 36a cannot be formed continuously. Namely, manufacturing steps must be inefficient.

### SUMMARY OF THE INVENTION

The present invention has been invented to solve the problems of the conventional thin film magnetic head.

An object of the present invention is to provide a soft magnetic film, which has superior soft magnetic characteristics and which is suitable for a thin film magnetic head.

Another object is to provide a thin film magnetic head having said soft magnetic film.

To achieve the objects, the present invention has following structures.

Namely, the soft magnetic film of the present invention comprises: a magnetic base layer including a ferromagnetic element; and a ferromagnetic layer being piled on the magnetic base layer. The soft magnetic film has uniaxial magnetic anisotropy. The magnetic base layer includes at least one element selected from Fe, Ni and Co as the ferromagnetic element.

In the soft magnetic film, the magnetic base layer may be made of an alloy of 81.3 at % NiFe or an alloy of 50 at % NiFe. Each of the alloys has high saturation magnetic flux density.

In the soft magnetic film, the ferromagnetic layer may be made of an alloy including at least Fe or Co. The alloy may further include at least one element selected from Al, B, Ga, Si, Ge, Y, Ti, Zr, Hf, V, Nb, Ta, Cr, Ni, Mo, W, Rh, Ru, Pd and Pt.

The soft magnetic film may further comprise an alloy layer made of 50 % NiFe, which is piled on the ferromagnetic layer. With this structure, corrosion of the ferromagnetic layer can be prevented.

The soft magnetic film may be used for a thin film magnetic head capable of writing data in a magnetic recording medium. The thin film magnetic head of the present invention comprises: a lower magnetic pole; and an upper magnetic pole being separated from the lower magnetic pole by a write-gap layer, wherein a magnetic base layer including a ferromagnetic element, a ferromagnetic layer and the upper magnetic pole are piled on the write-gap layer. The thin film magnetic head will be mounted on a head slider assembled in a magnetic disk drive unit.

Since the soft magnetic film of the present invention has high saturation magnetic flux density and superior soft magnetic characteristics, the soft magnetic film is suitable for a thin film magnetic head capable of writing data in a recording medium of a magnetic disk drive unit. Further, the thin film magnetic head including the soft magnetic film generates a strong magnetic field for writing data and has superior high frequency characteristics, so that data can be written in the recording medium with high recording density.

### BRIEF DESCRIPTION OF THE DRAWINGS

Embodiments of the present invention will now be described by way of examples and with reference to the accompanying drawings, in which:

FIG. 1 is a schematic plan view of a magnetic disk drive unit (HDD) showing an inner mechanism;

FIG. 2 is a schematic perspective view of a head slider;

FIG. 3 is a schematic plan view of a thin film magnetic head (an induction write-head element) relating to the present invention;

FIG. 4 is a sectional view of a read/write-head;

FIG. 5 is a sectional view showing a process of producing the read/write-head;

FIG. 6 is a sectional view showing the process of producing the read/write-head;

FIG. 7 is an explanation view of trimming an upper magnetic pole;

FIG. 8 is a graph showing BH hysteresis of the soft magnetic film relating to the present invention;

FIG. 9 is a graph showing BH hysteresis of the soft magnetic film relating to the present invention;

FIG. 10 is a graph showing BH hysteresis of a soft magnetic film of a comparative sample; and

FIG. 11 is a sectional view of the conventional read/write-head.

### DETAILED DESCRIPTION OF THE EMBODIMENTS

Preferred embodiments of the present invention will now be described in detail with reference to the accompanying drawings.

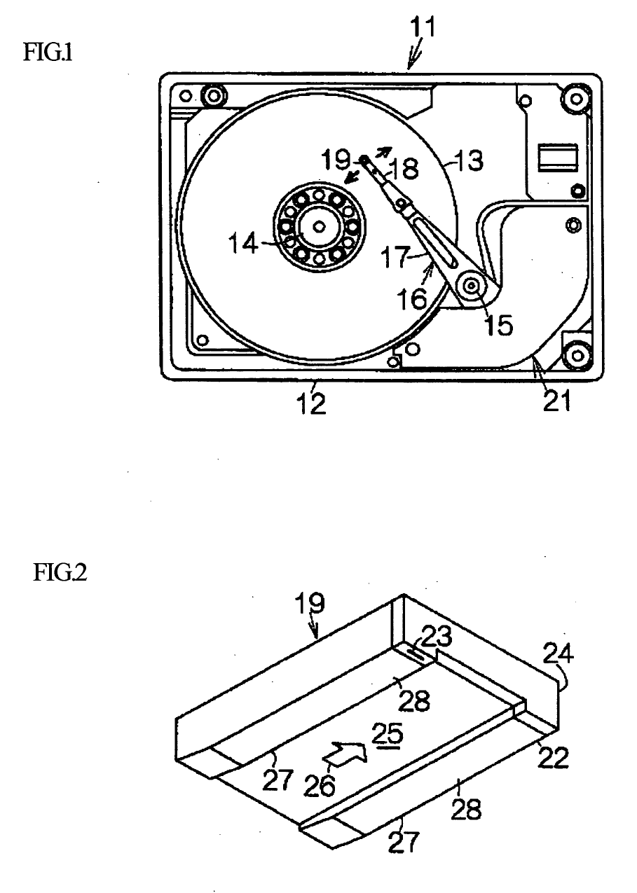

FIG. 1 is a schematic plan view of a magnetic disk drive unit 11 showing an inner mechanism. The disk drive unit 11 includes a thin film magnetic head. A magnetic disk 13, which is a magnetic recording medium, is accommodated in a rectangular body part 12 of the disk drive unit 11. The magnetic disk 13 is attached to a rotary shaft of a spindle motor 14. The spindle motor 14 rotates the magnetic disk 13 at high speed, e.g., 7200 rpm, 10000 rpm.

A carriage 16, which is capable of turning around a supporting shaft 15 arranged perpendicular to a disk surface of the magnetic disk 13, is accommodated in the body part 12. The carriage 16 comprises: an arm 17 horizontally extended from the supporting shaft 15; and an elastic suspension 18 provided to a front end of the arm 17 and extended forward therefrom.

A head slider 19 is provided to a front end of the suspension 18. A floating surface of the head slider 19 faces the disk surface of the magnetic disk 13. Elasticity of the suspension 18 biases the head slider 19 toward the surface of the magnetic disk 13. By rotating the magnetic disk 13, an air stream on the surface of the magnetic disk 13 generates a buoyancy force for floating the head slider 19. When the buoyancy force and the elasticity of the suspension 18 are balanced, the head slider 19 is floated.

By turning the carriage 16 around the supporting shaft 15 while floating the head slider 19, the head slider 19 is moved across the surface of the magnetic disk 13 in a radial direction thereof. With this action, the head slider 19 can be moved to a desired recording track of the magnetic disk 13. The carriage 16 is turned by an actuator 21, e.g., voice coil motor (VCM).

An example of the head slider 19 is shown in FIG. 2. The head slider 19 comprises: a slider proper 22 made of Al₂O₃—TiC (ALTIC); and a head element film 24 fixed to an air exit end of the slider proper 22. The head element film 24, which is made of alumina (Al₂O₃), includes a read/write-head 23. The floating surface 25, which faces the magnetic disk 13, is formed in the slider proper 22 and the head element film 24.

A pair of rails 27 are formed in the floating surface 25, and they are extended from an air entering end to the air exit end. Top surfaces of the rails 27 act as air bearing surfaces (ABS) 28, which generate the buoyancy force with an air steam 26.

An end of the read/write-head 23, which is formed in the head element film 24, is exposed in the ABS 28.

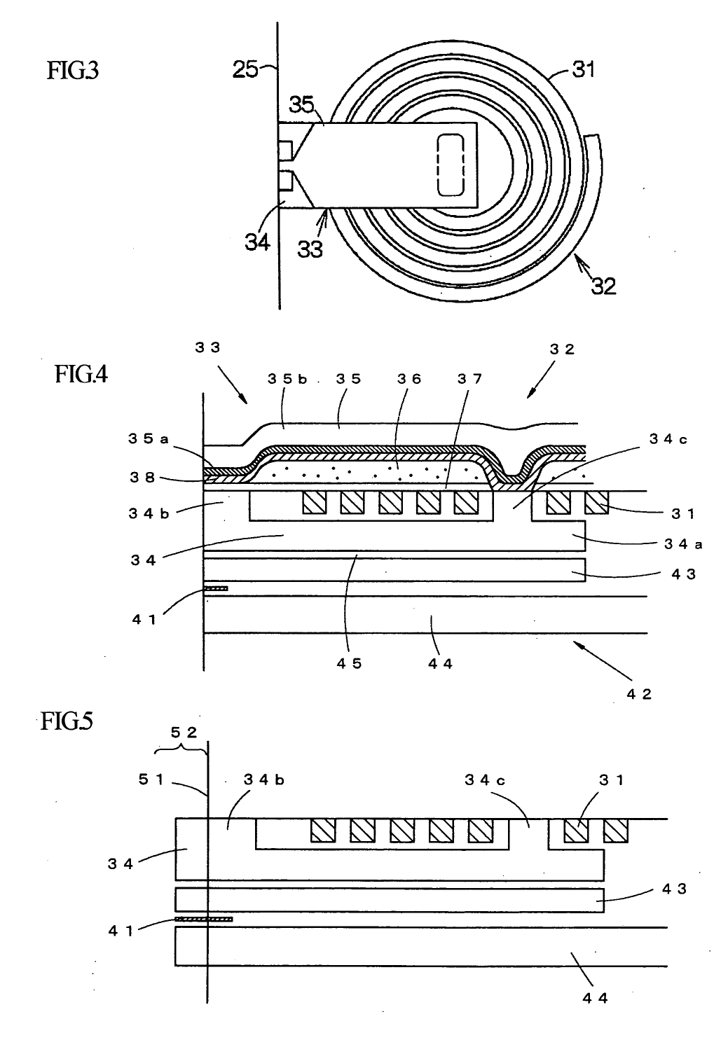

In FIG. 3, the read/write-head 23 is seen from the write-head side. The read/write-head 23 includes an induction write-head element 32, which writes data in the magnetic disk 13 by using a magnetic field generated by a convolution coil pattern 31. The induction write-head element 32 works as the thin film magnetic head of the present invention.

When the magnetic field is generated by applying an electric current to the coil pattern 31, a magnetic flux current runs through a core 33, which is pierced through the center of the coil pattern 31. The coil pattern 31 is made of a electric conductive material, e.g., Cu.

FIG. 4 is a sectional view of the read/write-head 23.

The magnetic core 33 is extended from the center of the convolution coil pattern 31 toward the floating face 25. A lower magnetic pole 34 and an upper magnetic pole 35 are formed in a front end face of the read/write-head 23, which corresponds to the floating surface 25. The lower magnetic pole 34 comprises: a magnetic pole layer 34a; a front pole piece 34b being provided on an outer side of the coil pattern 31, corresponding to the floating surface 25 and being extended upward from the magnetic pole layer 34a; and a rear pole piece 34c being provided at the center of the coil pattern 31 and being extended upward from the magnetic pole layer 34a. Top faces of the pole pieces 34b and 34c are included in the same horizontal plane. For example, the lower magnetic pole 34 is made of NiFe.

A nonmagnetic layer 37, whose front end is exposed in the floating surface 25, is formed on the lower magnetic pole 34 and horizontally extended backward.

A magnetic base layer 38, which includes a Ti layer of 50 angstrom and a ferromagnetic element, and a ferromagnetic layer 35a are piled on the nonmagnetic layer 37. A film of 50 at % NiFe, whose thickness is 200 angstrom, is formed on the ferromagnetic layer 35a. An insulating layer 36 is formed so as to make an apex angle of the upper magnetic pole 35.

The nonmagnetic layer 37, the magnetic base layer 38 and the ferromagnetic layer 35a are formed between the magnetic poles 34 and 35 so as to form the write-gap between the magnetic poles 34 and 35.

The magnetic base layer 38 formed on the Ti layer is made of, for example, an alloy of NiFe. The magnetic base layer 38 is made of an alloy including at least one ferromagnetic element selected from Fe, Ni and Co. The magnetic base layer 38 is an alloy film made of, for example, 81.3 at % NiFe having thickness of 20 angstrom, 50 at % NiFe having thickness of 50 angstrom.

The upper magnetic pole 35 comprises: the ferromagnetic layer 35a formed on the magnetic base layer 38, which is formed on the Ti layer; a magnetic pole layer 35b extended forward from the center of the coil pattern 31. A front end of the magnetic pole layer 35b is held by the ferromagnetic layer 35. A rear end of the upper magnetic pole 35 is connected to the rear pole piece 34c of the lower magnetic pole 34 at the center of the coil pattern 31.

The ferromagnetic layer 35a may be made of an alloy of FeCo. At least one element selected from O, N and C may be added to the FeCo alloy. Further, the FeCo alloy may include at least one element selected from Al, B, Ga, Si, Ge, Y, Ti, Zr, Hf, V, Nb, Ta, Cr, Ni, Mo, W, Rh, Ru, Pd and Pt. The ferromagnetic layer 35a may be made of an alloy including at least a ferromagnetic element, e.g., Fe, Co. The ferromagnetic layer 35a on the magnetic base layer 38 has soft magnetic characteristics and high saturation magnetic flux density, e.g., 2.4 T or more. The magnetic pole layer 35b is made of, for example, an alloy of NiFe.

As shown in FIG. 4, the read/write-head 23 further includes a read-head 42, which has a magnetic resistance effect (MR) element 41 for reading data from the magnetic disk 13. The MR element 41 is sandwiched between a pair of shielding layers 43 and 44. A read-gap is defined between the shielding layers 43 and 44. The shielding layers 43 and 44 are made of, for example, magnetic materials, e.g., FeN, NiFe. A great magnetic resistance effect element and a tunnel junction magnetic resistance effect element, etc. may be used as the MR element 41.

As shown in FIG. 4, in the read/write-head 23, a nonmagnetic layer 45, which has uniform thickness, is formed between the lower magnetic pole 34 of the induction write-head element 32 and the upper shielding layer 43 of the read-head 42. The nonmagnetic layer 45 magnetically separates the lower magnetic pole 34 from the upper shielding layer 43. The nonmagnetic layer 45 is made of, for example, Al₂O₃. Note that, the lower magnetic pole 34 of the induction write-head element 32 can act as the upper shielding layer 43 of the read-head 42.

When an electric current is applied to the coil pattern 31 of the induction write-head element 32, the coil pattern 31 generates a magnetic field. A magnetic flux current runs through the center of the coil pattern 31, the upper magnetic pole 35 and the lower magnetic pole 34. The magnetic flux current runs between the magnetic poles 34 and 35 with bypassing the nonmagnetic layer 37. The magnetic flux current leaked from the floating surface 25 generates a write-magnetic field or a recording magnetic field. The magnetic disk 13, which faces the floating surface 25, is magnetized by the write-magnetic field.

In induction write-head element 32, high saturation magnetic flux density can be gained at the end of the upper magnetic pole 35 of the induction write-head element 32. Therefore, a strong gap magnetic field or write-magnetic field can be formed in the write-gap of the induction write-head element 32. By using the strong write-magnetic field, the magnetic disk 13 may be made of a material having a high coercive force, so that number of tracks in a unit area can be increased and recording density can be made higher.

Next, a process of producing the induction write-head 32 will be briefly explained. Firstly, the shielding layers 43 and 44 and the MR element 41, which is formed between the shielding layers 43 and 44, are formed on an ALTIC wafer by a known method.

Note that, as shown in FIG. 5, the MR element 41 will be trimmed until reaching a standard plane 51, so that the MR element 41 will be exposed in the standard plane 51 or the floating surface 25.

The lower magnetic pole 34 and the coil pattern 31 are formed on the upper shielding layer 43. Top faces of the front pole piece 34b and the rear pole piece 34c are flattened and exposed by flattening treatment.

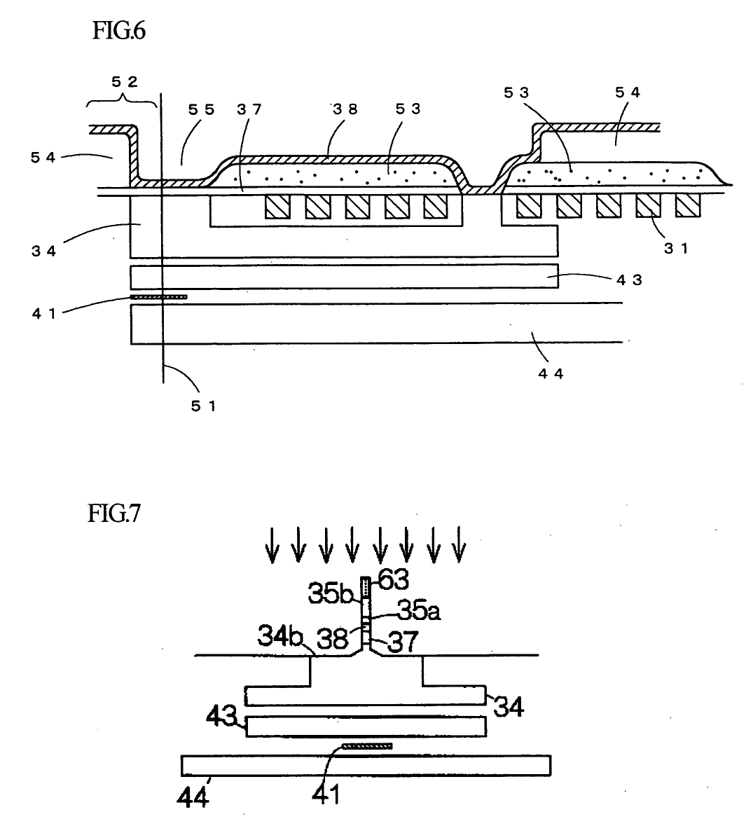

As shown in FIG. 6, the nonmagnetic layer 37 is formed on the flattened top faces. Bosses 53, which are nonmagnetic films made of, for example, Al₂O₃, are formed on the nonmagnetic layer 37. Then, a photoresist film 54 is formed on the bosses 53 and the nonmagnetic layer 37. A concave part 55, which corresponds to a shape of the upper magnetic pole 35, is formed in the photoresist film 54.

The magnetic base layer 38 and the ferromagnetic layer 35a are formed in the concave part 55 by spattering. In the present embodiment, as described above, the Ti layer, the magnetic base layer 38 and the ferromagnetic layer 35a are continuously formed.

A target for forming the ferromagnetic layer 35a is made of a CoFe alloy, e.g., FeCo, FeCoN, FeCoAlO. In the present embodiment, the ferromagnetic layer 35a is formed on the magnetic base layer 38 by a deposition on the planetary rotating substrates method, so that an easy axis of magnetization can be arranged in a direction of orbital motion.

Next, the magnetic pole layer 35b is formed, by spattering, on the ferromagnetic layer 35a in the concave part 55. Therefore, the upper magnetic pole 35, which is extended from the center of the coil pattern 31 toward the standard plane 51, is formed in the concave part 55.

Then, as shown in FIG. 7, the upper magnetic pole 35 is trimmed. A photoresist film 63 is formed on the upper magnetic pole 35 for trimming. The trimming is performed, by ion milling, so as to make the upper magnetic pole 35, the magnetic base layer 38 and the nonmagnetic layer 37 thin. Further, the lower magnetic pole 34 is also trimmed.

By performing the trimming step, the induction write-head element 32 is completed. Finally, the induction write-head element 32 is covered with a nonmagnetic film, e.g., Al₂O₃, then a trimming stock 52 is removed.

The inventors of the present invention measured soft magnetic characteristics of samples of the soft magnetic films of the present invention and a comparative sample. The results are shown in FIGS. 8-10, which are BH hysteresis in directions parallel to and perpendicular to orientation flats of the samples.

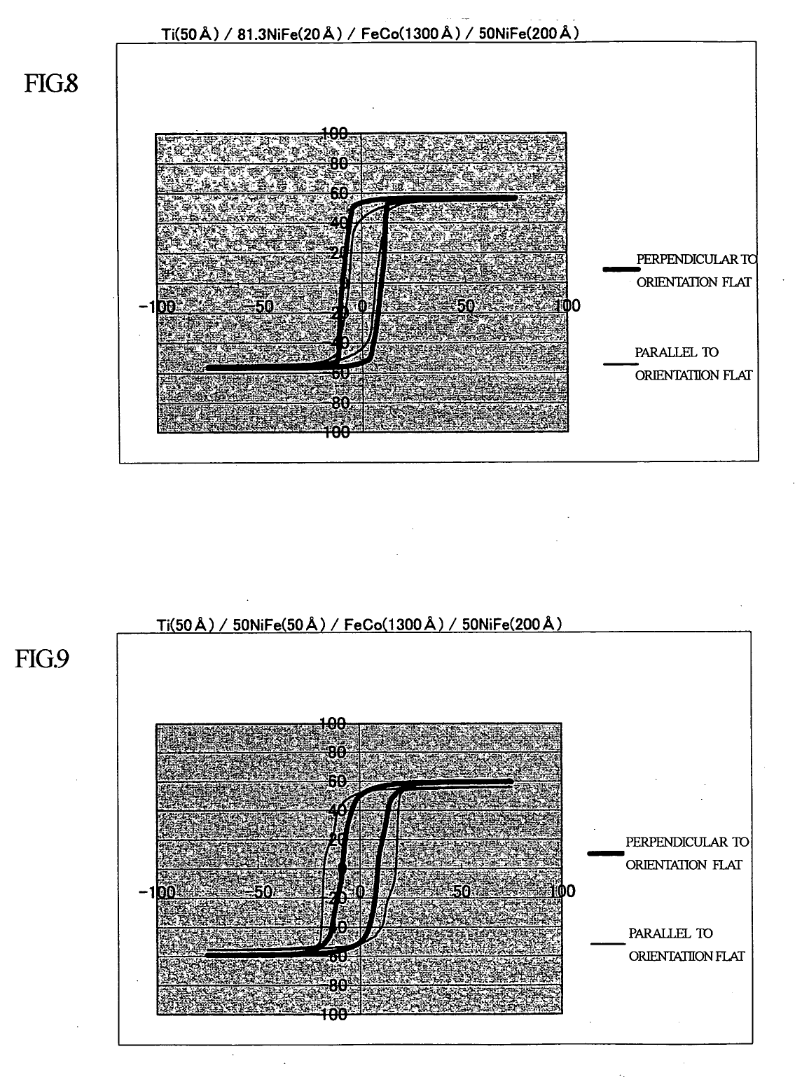

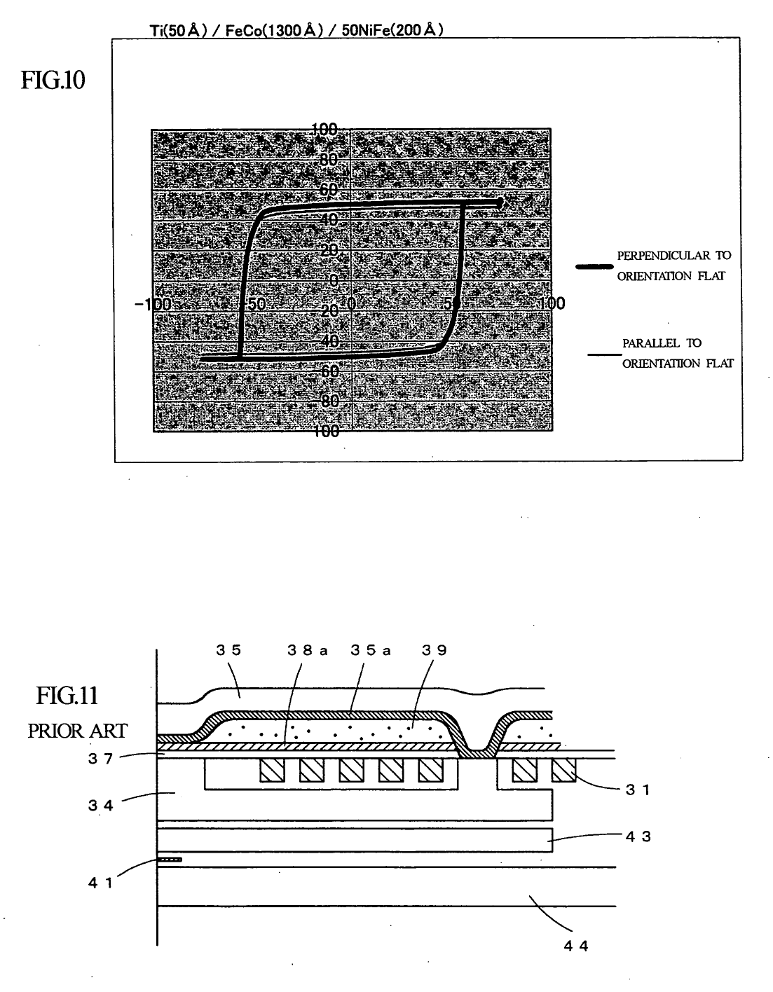

The sample of the present invention shown in FIG. 8 had the following constitution: the Ti layer (thickness 50 angstrom)/the magnetic base layer of 81.3 at % NiFe (thickness 20 angstrom)/the ferromagnetic layer of FeCo (thickness 1300 angstrom)/50 at % NiFe (thickness 200 angstrom). The sample of the present invention shown in FIG. 9 had the following constitution: the Ti layer (thickness 50 angstrom)/the magnetic base layer of 50 at % NiFe (thickness 50 angstrom)/the ferromagnetic layer of FeCo (thickness 1300 angstrom)/50 at % NiFe (thickness 200 angstrom). The comparative sample shown in FIG. 10 had the following constitution: a Ti layer (thickness 50 angstrom)/a ferromagnetic layer of FeCo (thickness 1300 angstrom)/50 at % NiFe (thickness 200 angstrom). All of the samples were formed by spattering, and the ferromagnetic layers were formed by the deposition on the planetary rotating substrates method.

According to FIGS. 8 and 9, the magnetic films, in each of which the ferromagnetic film was formed on the magnetic base layer, had suitable uniaxial magnetic anisotropy.

On the other hand, according to FIG. 10, the comparative sample, which had no magnetic base layer, had isotropic magnetic characteristics. Namely, the uniaxial magnetic anisotropy could not be gained.

According to the results, the suitable soft magnetic film can be produced by forming the ferromagnetic layer on the magnetic base layer. Therefore, by using the soft magnetic film of the present invention, a write-magnetic field of a thin film magnetic head can be effectively improved, and the thin film magnetic head is capable of recording data with high recording density.

Further, the soft magnetic film of the present invention, which includes the magnetic base layer and the ferromagnetic layer, can be easily removed by etching. Therefore, useless parts of the soft magnetic film can be easily removed by etching after the upper magnetic pole 35 is formed. The thin film magnetic head can be easily produced.

Since the NiFe layer is formed on the surface of the ferromagnetic layer 35a, corrosion of the ferromagnetic layer can be prevented.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A soft magnetic film,
comprising:
a magnetic base layer including a ferromagnetic element; and
a ferromagnetic layer being piled on said magnetic base layer.

2-6. (canceled)

7. The soft magnetic film according to claim 1,
wherein said magnetic base layer is made of an alloy of including at least Fe, Ni or Co.

8. The soft magnetic film according to claim 1,
wherein said magnetic base layer is made of an alloy of 81.3 at % NiFe.

9. The soft magnetic film according to claim 1,
wherein said magnetic base layer is made of an alloy of 50 at % NiFe.

10. The soft magnetic film according to claim 1,
wherein said ferromagnetic layer is made of an alloy including at least Fe or Co.

11. The soft magnetic film according to claim 5,
wherein said ferromagnetic layer is made of FeCo alloy.

12. The soft magnetic film according to claim 6,
wherein said FeCo alloy includes at least one element selected from O, N and C.

13. The soft magnetic film according to claim 7,
wherein said FeCo alloy includs at least one element selected from Al, B, Ga, Si, Ge, Y, Ti, Zr, Hf, V, Nb, Ta, Cr, Ni, Mo, W, Rh, Ru, Pd and Pt.

14. The soft magnetic film according to claim 1,
further comprising an alloy layer made of 50 % NiFe, which is piled on said ferromagnetic layer.

15. A thin film magnetic head,
comprising:
a lower magnetic pole; and
an upper magnetic pole being separated from said lower magnetic pole by a write-gap layer,
wherein a magnetic base layer including a ferromagnetic element, a ferromagnetic layer and said upper magnetic pole are piled on said write-gap layer.

16. A thin film magnetic head according to claim 10,
wherein said magnetic base layer is made of an alloy including at least Fe, Ni or Co.

17. A thin film magnetic head according to claim 10,
wherein said magnetic base layer is made of an alloy of 81.3 at % NiFe.

18. A thin film magnetic head according to claim 10,
wherein said magnetic base layer is made of an alloy of 50 at % NiFe.

19. A thin film magnetic head according to claim 10,
wherein said ferromagnetic layer is made of an alloy including at least Fe or Co.

20. A thin film magnetic head according to claim 14,
wherein said ferromagnetic layer is made of FeCo alloy.

21. A thin film magnetic head according to claim 15,
wherein said FeCo alloy includes at least one element selected from O, N and C.

22. A thin film magnetic head according to claim 16,
wherein said FeCo alloy includs at least one element selected from Al, B, Ga, Si, Ge, Y, Ti, Zr, Hf, V, Nb, Ta, Cr, Ni, Mo, W, Rh, Ru, Pd and Pt.

23. A thin film magnetic head according to claim 17,
further comprising an alloy layer made of 50 % NiFe, which is piled on said ferromagnetic layer.
